(19) United States
(12) Patent Application Publication
(10) Pub. No.: US 2014/0015802 A1
(43) Pub. Date: Jan. 16, 2014

(54) OPTICAL TOUCH METHOD AND SYSTEM THEREOF

(71) Applicant: WISTRON CORPORATION, New Taipei City (TW)

(72) Inventors: Kou-Hsien Lu, New Taipei City (TW); Shang-Chin Su, New Taipei City (TW); Hsun-Hao Chang, New Taipei City (TW)

(73) Assignee: WISTRON CORPORATION, New Taipei City (TW)

(21) Appl. No.: 13/781,803

(22) Filed: Mar. 1, 2013

(30) Foreign Application Priority Data
Jul. 13, 2012 (TW) 101125279

(51) Int. Cl. G06F 3/042

(52) U.S. Cl. CPC G06F 3/042
USPC 345/175

(57) ABSTRACT

An optical touch method for sensing touch points triggered on an optical touch panel is provided. The method includes: obtaining a first to a third luminance distribution images by a first, a second and an auxiliary image capturing devices respectively; obtaining a number of pieces of coordinate information according to the first and the second luminance distribution images; defining the viewable area of the auxiliary image capturing device; determining whether each of the coordinate information falls within the viewable area; if so, comparing each of the coordinate information with the third luminance distribution image by a processing core device to determine whether each of the coordinate information corresponds to a real touch point.

This application claims the benefit of Taiwan application Serial No. 101125279, filed Jul. 13, 2012, the subject matter of which is incorporated herein by reference.

### TECHNICAL FIELD

The disclosure relates in general to an optical touch method and an optical touch system thereof, and more particularly to an optical touch method capable of effectively removing dummy ghost points and an optical touch system thereof.

### BACKGROUND

With the advance and development in technology, touch display has been widely used in various electronic products. Let the optical touch panel be taken for example. An optical touch panel includes a light source and image sensors. When the user triggers a touch event on the touch range, the touch point blocks the proceeding of the light, and the image sensor senses a dark point corresponding to the touch point position. Then, the angle contained between a connecting line (formed by the touch point position and the image sensor) and an edge of the touch panel is calculated according to the position of the dark point. Since the angle is obtained and the distance between the image sensors is known, the coordinate of the touch point on the display panel can thus be obtained by the triangulation method.

However, when multiple touch points are triggered in the optical touch panel and the conventional optical touch panel has to remove the dummy ghost points, the touch points can thus be erroneously sensed. Therefore, how to provide an optical touch method capable of effectively recognizing dummy ghost points has become a prominent task for the industries.

### SUMMARY OF THE DISCLOSURE

According to an embodiment of the present disclosure, an optical touch system used in an optical touch panel is provided. The optical touch system senses N touch points triggered on the optical touch panel, wherein N is a positive integer greater than 1. The optical touch system includes a first, a second and a first auxiliary image capturing device, and a processing core device. The first and the second image capturing device are respectively disposed on a first and a second terminal corner on the optical touch panel to respectively obtain a first and a second luminance distribution image. The first and the second terminal corner are adjacent to each other. The first auxiliary image capturing device is disposed on a lateral side of the optical touch panel to obtain a third luminance distribution image. The processing core device is coupled to the first, the second and the first auxiliary image capturing device, and obtains Nⁿ pieces of the coordinate information according to the first and the second luminance distribution image. The processing core device further defines the first viewable area of the first auxiliary image capturing device on the optical touch panel, and correspondingly determines whether each of the Nⁿ pieces of the coordinate information falls within the first viewable area. The processing core device further compares a first target coordinate information, which falls within the first viewable, with the third luminance distribution image to determine whether the first target coordinate information corresponds to a real touch point.

According to another embodiment of the present disclosure, an optical touch method used in an optical touch system is provided. The optical touch method is for sensing N touch points triggered on an optical touch panel, wherein N is a positive integer greater than 1. The optical touch method includes a following steps of: obtaining the first to the third luminance distribution images by the first, the second image and the first auxiliary image capturing devices of the optical touch system respectively, wherein the first and the second image capturing device are respectively disposed on the first and the second terminal corner of the optical touch panel and the first and the second terminal corners are adjacent to each other, and the first auxiliary image capturing device is disposed on a lateral side of the optical touch panel; receiving and obtaining Nⁿ pieces of the coordinate information by the processing core device of the optical touch system according to the first and the second luminance distribution image; defining a first viewable area of the first auxiliary image capturing device by the processing core device on the optical touch panel; determining by the processing core device whether each of the Nⁿ pieces of the coordinate information falls within the first viewable area; and comparing a first target coordinate information, which falls within the first viewable, with the third luminance distribution image by the processing core device to determine whether the first target coordinate information corresponds to a real touch point.

The above and other contents of the disclosure will become better understood with regard to the following detailed description of the preferred but non-limiting embodiment(s). The following description is made with reference to the accompanying drawings.

### BRIEF DESCRIPTION OF THE DRAWINGS

FIG. 1 shows a block diagram of an optical touch system according to an embodiment of the disclosure;

FIG. 2A and FIG. 2B respectively show luminance distribution images Im_{—}1 and Im_{—}2.

FIG. 3 shows another schematic diagram of an optical touch system 1 according to an embodiment of the disclosure;

FIG. 4 shows a flowchart of an optical touch method according to an embodiment of the disclosure;

FIG. 5 shows another block diagram of an optical touch system according to an embodiment of the disclosure;

FIG. 6 shows a disposition diagram of an auxiliary image capturing device according to an embodiment of the disclosure;

FIGS. 7A-7C are another flowchart of an optical touch method according to an embodiment of the disclosure.

### DETAILED DESCRIPTION OF THE DISCLOSURE

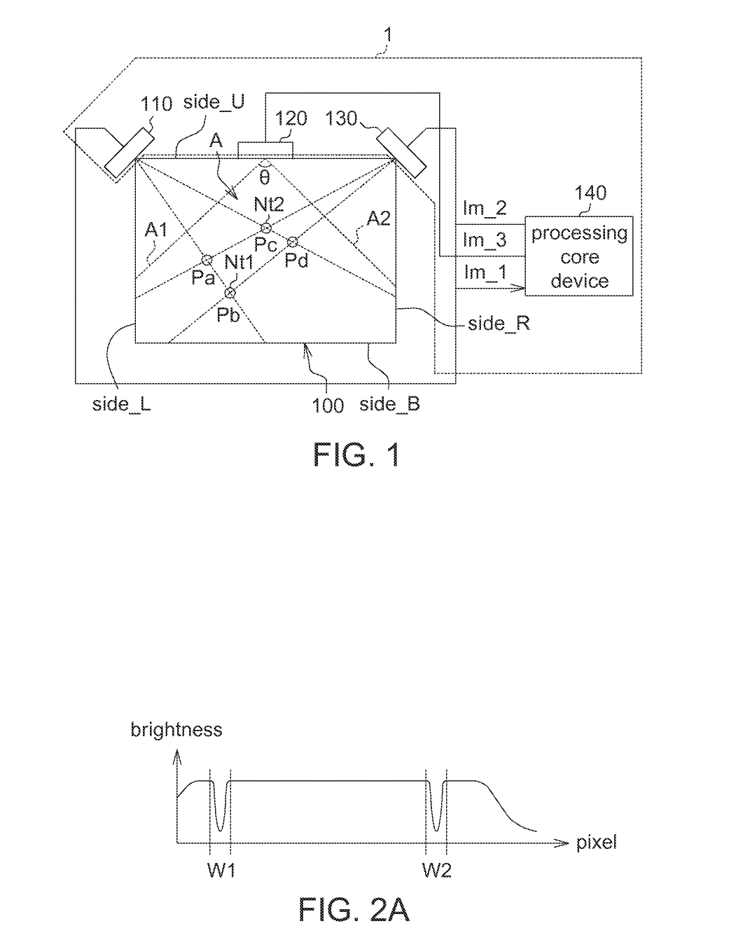

Referring to FIG. 1, a block diagram of an optical touch system according to an embodiment of the disclosure is shown. An optical touch system 1 is used in an optical touch panel 100 for sensing N touch points Nt1, Nt2, . . . , NtN on an optical touch panel 100, wherein N is a positive integer greater than 1.

The optical touch system 1 includes an image capturing devices 110, 130, an auxiliary image capturing device 120 and a processing core device 140. The image capturing devices 110 and 130 are respectively disposed at two adjacent corners on the optical touch panel 100 for capturing images of the optical touch panel 100 to obtain luminance distribution images Im_{—}1 and Im_{—}2 respectively. For example, the image capturing device 110 is disposed at the top left corner between the left-hand side side_L and the upper side side_U of the optical touch panel 100 and the image capturing device 130 is disposed at the top right corner between the right-hand side side_R and the upper side side_U of the optical touch panel 100 as indicated in FIG. 1. The viewable angles of the image capturing devices 110 and 130 are substantially lager than or equal to 90 degrees, such that all areas on the optical touch panel 100 are substantially within the viewable ranges of the image capturing devices 110 and 130.

The auxiliary image capturing device 120 is disposed on a lateral side of the optical touch panel 110 for capturing images to obtain a luminance distribution image Im_{—}3. For example, the auxiliary image capturing device 120 is disposed at a middle point on the top upper side side_U of the optical touch panel 110.

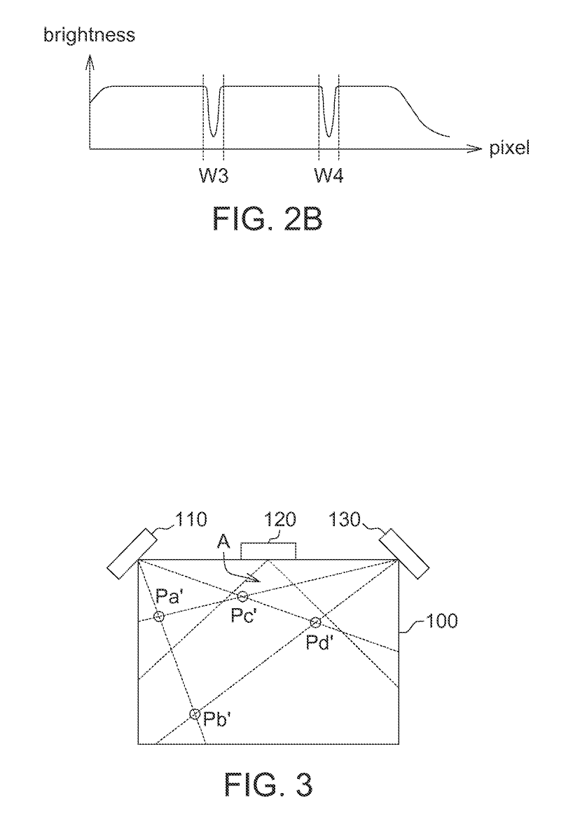

The processing core device 140 is coupled to the image capturing devices 110 and 130 and the auxiliary image capturing device 120 for obtaining Nⁿ or less than Nⁿ pieces of the coordinate information according to luminance distribution images Im_{—}1 and Im_{—}2. Let N be equal to 2 in an operating example. The touch points Nt1 and Nt2 are triggered on the optical touch panel 100 as indicated in FIG. 1. In the present operating example, the image capturing devices 110 and 130 respectively obtain luminance distribution images Im_{—}1 and Im_{—}2 from their respective positions as indicated in FIG. 2A and FIG. 2B.

Two segments of dark portion positions W1 and W2 on the luminance distribution image Im_{—}1 correspondingly denote positions of two touch points Nt1 and Nt2. Likewise, two segments of dark portion positions W3 and W4 on the luminance distribution image Im_{—}2 correspondingly denote positions of two touch points Nt1 and Nt2.

Information of the relationship between the dark portion positions W1 and W2 and the touch points Nt1 and Nt2 and the information of the relationship between the dark portion positions W3 and W4 and the touch points Nt1 and Nt2 are not clearly marked in the luminance distribution images Im_{—}1 and Im_{—}2. Therefore, the processing core device 140 obtains four pieces of coordinate information C(W1,W3), C(W1,W4), C(W2,W3) and C(W2,W4) according to the combinations of the two dark portions positions W1 and W2 on the luminance distribution image Im_{—}1 and the two dark portion positions W3 and W4 on the luminance distribution image Im_{—}2 respectively. The four pieces of coordinate information C(W1,W3), C(W1,W4), C(W2,W3) and C(W2,W4) respectively correspond to four touch positions Pa, Pb, Pc and Pd as indicated in FIG. 1.

Referencing FIG. 1. Two of the four pieces of the coordinate information C(W1,W3), C(W1,W4), C(W2,W3) and C(W2,W4) correspond to real touch points Nt1 and Nt2, and the other two of the four pieces of the coordinate information correspond to dummy ghost points. If only considering the luminance distribution images Im_{—}1 and Im_{—}2, the processing core device 140 may be not correctly recognize which two of the four pieces of the coordinate information corresponds to real touch points, and which two of the four pieces correspond to dummy ghost points.

The processing core device 140 further defines a viewable area A of the auxiliary image capturing device 120 on the optical touch panel 100, and correspondingly determines whether each of the Nⁿ pieces of the coordinate information falls within the viewable area A. To put it in greater details, the processing core device 140 may obtain one or more linear equations for defining the viewable area A by referencing the position information of the auxiliary image capturing device 120 on the optical touch panel 100 and the viewable angle information of the auxiliary image capturing device 120.

For example, the processing core device 140 defines the bottom side side_B and the left-hand side side_L of the optical touch panel 100 as the x coordinate axis and the y coordinate axis respectively and defines the bottom left terminal corner of the optical touch panel 100 as the original point (0,0) of the coordinates. The position of the auxiliary image capturing device 120 correspondingly is expressed as coordinates (Lb/2, La), wherein Lb denotes the lengths of the upper side side_U and the bottom side side_B of the optical touch panel 100, and La denotes the lengths of the left-hand side side_L and the right-hand side side_R.

The processing core device 140 further obtains a slop of two border lines A1 and A2 of the viewable area A by referencing the viewable angle information of the auxiliary image capturing device 120. In an operating example, the viewable angle θ of the auxiliary reference image capturing device 120 is 90 degrees, and is bisected by a norm of the sensing surface of the auxiliary image capturing device 120. In other words, the viewable area border line A1 is expressed by a linear equation passing through the coordinates (Lb/2, La) with the slope equal to 1. The viewable area border line A2 is correspondingly expressed by a linear equation passing through coordinate (Lb/2, La) with the slope equal to −1. Therefore, the processing core device 140 may obtain the linear equations of the border lines A1 and A2 of the viewable area A according to the position coordinates (Lb/2, La) of the auxiliary image capturing device 120 and the slopes of the border lines A1 and A2.

The processing core device 140 further converts each of the Nⁿ pieces of the coordinate information C(W1,W3), C(W1,W4), C(W2,W3) and C(W2,W4) to obtain the coordinate information C_xy(W1,W3), C_xy(W1,W4) C_xy(W2,W3) and C_xy(W2,W4) under xy coordinate system. The processing core device 140 further plug each of coordinate information C_xy(W1,W3), C_xy(W1,W4) C_xy(W2,W3) and C_xy(W2,W4) to the linear equations of the border lines A1 and A2 to determine whether each of the touch positions Pa˜Pd falls within the viewable area A. In the operating example of FIG. 1, each of the touch positions Pa˜Pd falls within the viewable area A.

The processing core device 140 further checks whether the luminance distribution image Im_{—}3 contains dark portion positions corresponding to the coordinate information C_xy(W1,W3), C_xy(W1,W4) C_xy(W2,W3) and C_xy(W2,W4) to determine whether each of the corresponding touch positions Pa˜Pd corresponds to a real touch point. For example, since the luminance distribution image Im_{—}3 contains dark portion positions corresponding to the positions Pb and Pc, the processing core device 140 determines that the corresponding coordinate information C_xy(W1,W4) and C_xy(W2,W3) of the position Pb and Pc correspond to real touch points. Conversely, since the luminance distribution image Im_{—}3 does not contain any dark portion positions corresponding to the touch position Pa and Pd, the processing core device 140 determines that the corresponding coordinate information C_xy(W1,W3) and C_xy(W2,W4) of the touch position Pa and Pd correspond to dummy ghost points.

In other words, by additionally referencing the luminance distribution image Im_{—}3, the optical touch system 1 of the present embodiment may determine which of the Nⁿ pieces of the coordinate information corresponds to a dummy ghost point and which corresponds to a real touch point, for positioning the touch points Nt1˜NtN.

Although the present embodiment is exemplified by the situation that each of the touch positions Pa˜Pd falls within the viewable area A, the optical touch system 1 of the present embodiment is not limited thereto. In other examples, some of the touch positions Pa′˜Pd′ may fall outside the viewable area A as indicated in FIG. 3. Under such circumstance, according to a method similar that disclosed above, the optical touch system 1 of the present embodiment may determine whether the positions Pb′, Pc′ and Pd′, which falling within the viewable area A, correspond to real touch points, but wherein the touch position Pa′ falling outside the viewable area A is excluded in the determination.

Although the present embodiment is exemplified by the situation that the image capturing device 130 is disposed at the middle point on a common lateral side (that is, the upper side side_U) of the image capturing devices 110 and 130, the image capturing device 130 of the present embodiment is not limited thereto. In other examples, the image capturing device 130 may be selectively disposed on other lateral sides or terminal corners, or at a position other than the middle point on any lateral side.

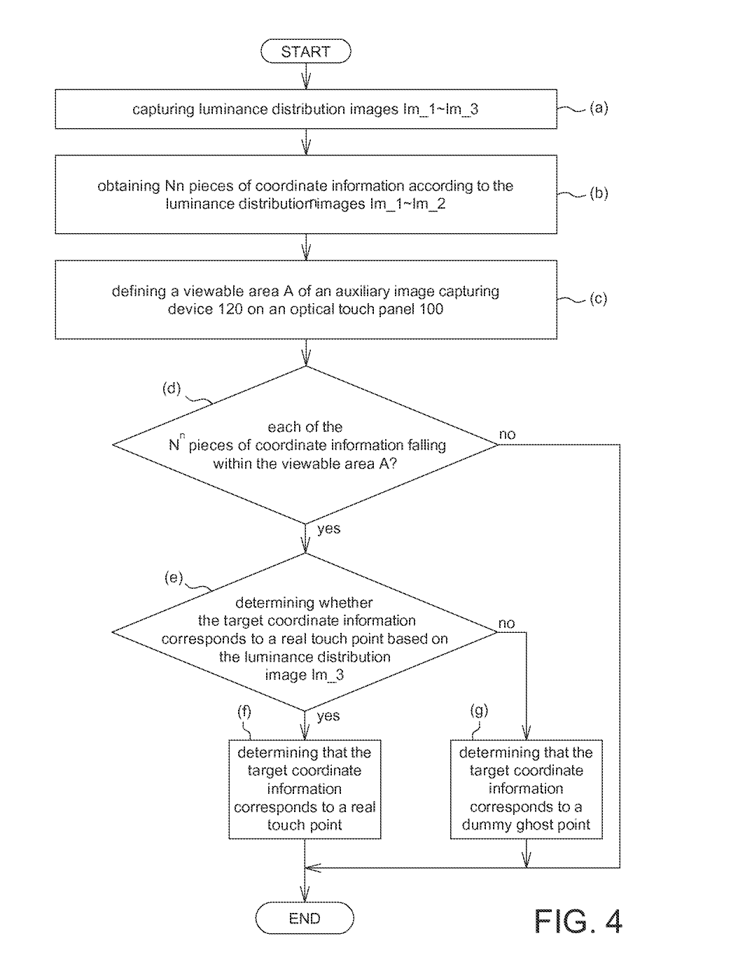

Referencing FIG. 4, a flowchart of an optical touch method according to an embodiment of the disclosure is shown. Detailed descriptions of the operating steps of the optical touch method of the present embodiment are already disclosed above, and are not repeated here.

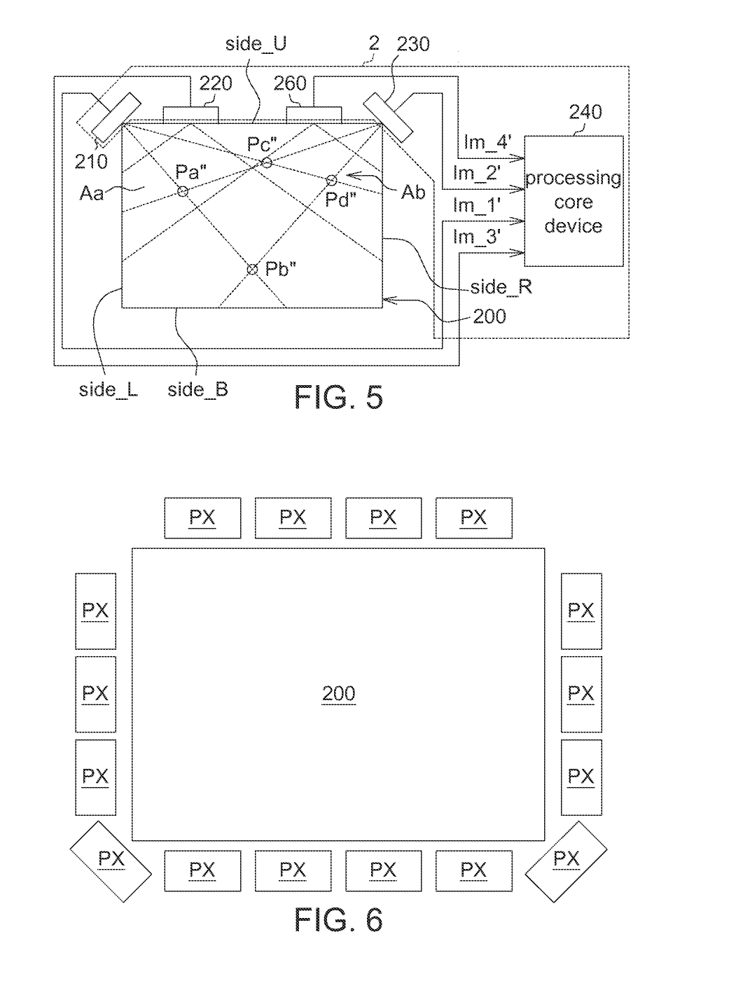

Although the present embodiment is exemplified by the situation that the optical touch system 1 includes two image capturing devices 110 and 130 and one auxiliary image capturing device 120, the optical touch system 1 of the present embodiment is not limited thereto. In other examples, the optical touch system 2 may include two or more than two auxiliary capturing devices 220 and 260 as indicated in FIG. 5.

In the operating example indicated in FIG. 5, the optical touch system 2 further includes another auxiliary image capturing device 260. The auxiliary image capturing devices 260 and the auxiliary image capturing device 220 both are disposed on the upper side side_U of the optical touch panel 200 and coupled to the processing core device. The auxiliary image capturing devices 220 and 260 respectively have viewable areas Aa and Ab which are partly overlapped.

The processing core device 240 determines whether the touch positions Pa″˜Pd″ corresponding to the coordinate information fall within the viewable area Aa or the viewable area Ab and correspondingly divides the touch positions Pa″˜Pd″ into the following categories: Category (1): the touch positions Pa″˜Pd″ falling outside the viewable areas Aa and Ab. Category (2): the touch positions Pa″˜Pd″ falling within the viewable area Aa but outside the viewable area Ab. Category (3): the touch positions Pa″˜Pd″ falling within the viewable area Ab but outside the viewable area Aa. Category (4): the touch positions Pa″˜Pd″ falling within the viewable areas Aa and Ab. In the operating example indicated in FIG. 5, the touch position Pa″ belongs to category (2), the positions Pc″ and Pd″ belong to category (3), and the position Pb″ belongs to category (4).

In terms of the touch position Pa″ belonging to category (2), the processing core device 240 may correspondingly determine whether the luminance distribution image Im_{—}3′ obtained by the auxiliary image capturing device 220 contains any dark portion positions corresponding to the coordinate information to determine whether the corresponding touch position Pa″ corresponds to a real touch point according to a method similar that disclosed above. In terms of the positions Pc″ and Pd″ belonging to category (3), the processing core device 240 may determine whether the luminance distribution image Im_{—}4′ obtained by the auxiliary image capturing device 260 contains any dark portion positions corresponding to the position Pc″ and Pd″ and accordingly determine whether the corresponding touch positions Pc″ and Pd″ correspond to real touch points.

In terms of the position Pb″ belonging to category (4), the position Pb″ falls within both of the viewable areas Aa and Ab. Therefore, the processing core device 240 determines whether both the luminance distribution images Im_{—}3′ and Im_{—}4′ contain any dark portion positions corresponding to the position Pb″ to determine whether the corresponding touch position corresponds to a real touch point. For example, when both of the luminance distribution images Im_{—}3′ and Im_{—}4′ contain a dark portion position corresponding to the position Pb′, the processing core device 240 correspondingly determines that the real touch point is triggered at the position Pb′. Conversely, when the position Pb″ correspond to none of dark portion positions on the luminance distribution image Im_{—}3′ and none of dark portion positions on the luminance distribution image Im_{—}4′, the processing core device 240 determines the point triggered at the position Pb″ as a dummy ghost point.

Although the present embodiment is exemplified by the situation that both the auxiliary image capturing devices 220 and 260 are disposed on the upper side side_U of the optical touch panel 200, the optical touch system 2 of the present embodiment is not limited thereto. Any designs with the auxiliary image capturing device disposed around the optical touch panel 200 and correspondingly containing a viewable area different from that obtained by the image capturing devices 210 and 230 are within the scope of protection of the optical touch system of the disclosure. For example, the auxiliary image capturing devices 220 and 260 may be selectively disposed at any other two positions PX of the optical touch panel 300 as indicated in FIG. 6.

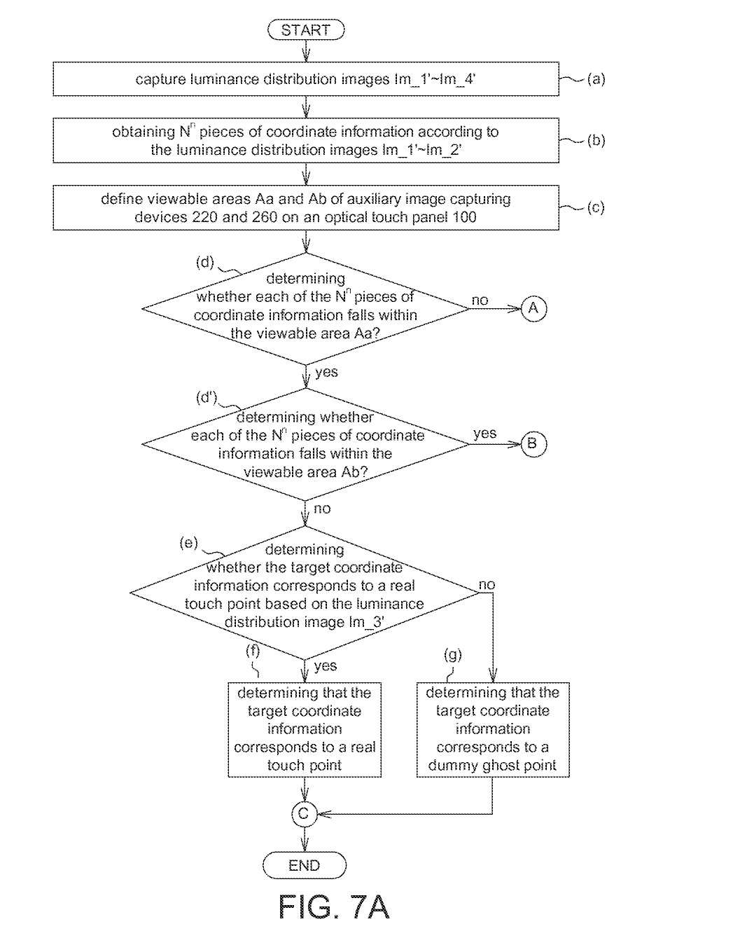

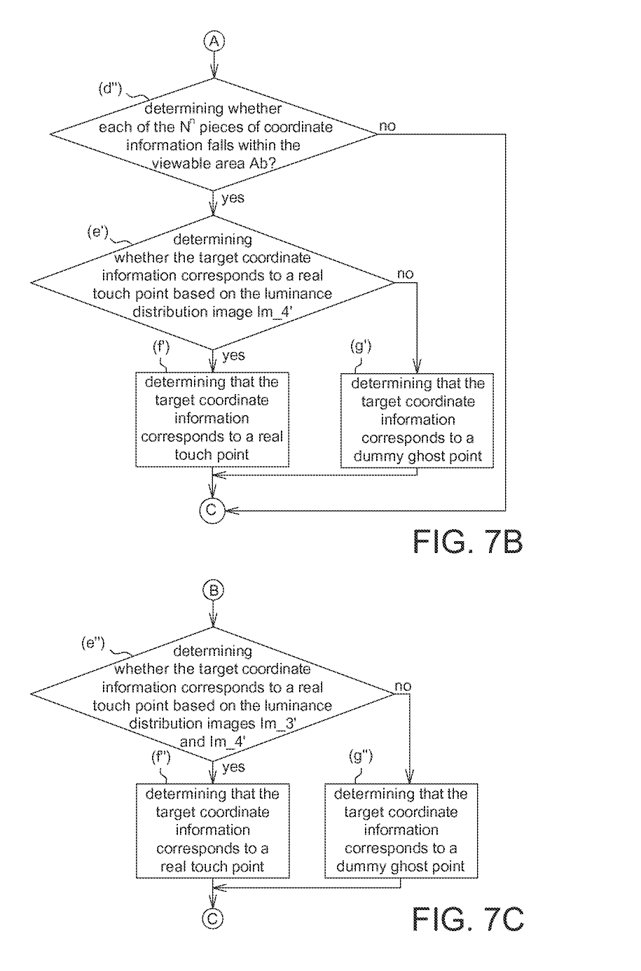

Referencing FIGS. 7A-7C, another flowchart of an optical touch method according to an embodiment of the disclosure is shown. Detailed descriptions of the operating steps of the optical touch method of the present embodiment are already disclosed above, and are not repeated here.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. An optical touch system used in an optical touch panel for sensing N touch points triggered on the optical touch panel, wherein N is a positive integer greater than 1, and the optical touch system comprises:
a first image capturing device and a second image capturing device respectively disposed a first terminal corner and a second terminal corner of on the optical touch panel for obtaining a first luminance distribution image and a second luminance distribution image, wherein the first terminal corner and the second terminal corner are adjacent to each other;
a first auxiliary image capturing device disposed on a lateral side of the optical touch panel for obtaining a third luminance distribution image; and
a processing core device coupled to the first, the second and the first auxiliary image capturing device and used for obtaining Nⁿ pieces of the coordinate information according to the first and the second luminance distribution image, wherein the processing core device defines a first viewable area of the first auxiliary image capturing device on the optical touch panel and correspondingly determines whether each of the Nⁿ pieces of the coordinate information falls within the first viewable area;
wherein, the processing core device compares a first target coordinate information, which falls within the first viewable area, with the third luminance distribution image to determine whether the first target coordinate information corresponds to a real touch point.

2. The optical touch system according to claim 1, wherein
if the first target coordinate information corresponds to a dark portion position on the third luminance distribution image, the processing core device determines that the first target coordinate information corresponds to a real touch point;
if the first target coordinate information does not correspond to any dark portion positions on the third luminance distribution image, the processing core device determines that the first target coordinate information corresponds to a dummy ghost point.

3. The optical touch system according to claim 1, wherein
the processing core device obtains a plurality of linear equations by referencing a first viewable angle information and a relative position information between the first auxiliary image capturing device and the optical touch panel, and accordingly defines the first viewable area on the optical touch panel; and
the processing core device substitutes each of the Nⁿ pieces of the coordinate information into the linear equations to determine whether each of the Nⁿ pieces of the coordinate information falls within the first viewable area.

4. The optical touch system according to claim 1, further comprising:
a second auxiliary image capturing device disposed on a lateral side of the optical touch panel and coupled to the processing core device for obtaining a fourth luminance distribution image;
wherein the processing core device defines a second viewable area of the second auxiliary image capturing device on the optical touch panel, and correspondingly determines whether each of the Nⁿ pieces of the coordinate information falls within the second viewable area;
the processing core device compares the second target coordinate information, which falls outside the first viewable but within the second viewable area, with the fourth luminance distribution image to determine whether the second target coordinate information corresponds to a real touch point;
wherein, the processing core device compares the third target coordinate information, which falls within the first viewable area and within the second viewable area, with the third and the fourth luminance distribution images to determine whether the second target coordinate information corresponds to a real touch point.

5. The optical touch system according to claim 4, wherein
if the second target coordinate information corresponds to a dark portion position on the fourth luminance distribution image, the processing core device determines that the second target coordinate information corresponds to a real touch point;
if the second target coordinate information does not correspond to any dark portion positions on the fourth luminance distribution image, the processing core device determines that the second target coordinate information corresponds to a dummy ghost point.

6. The optical touch system according to claim 4, wherein
if the third target coordinate information corresponds to a first dark portion position on the third luminance distribution image and corresponds to a second dark portion position on the fourth luminance distribution image, the processing core device determines that the third target coordinate information corresponds to a real touch point;
if the third target coordinate information does not correspond to any dark portion positions on the third luminance distribution image or if the third target coordinate information does not correspond to any dark portion positions on the fourth luminance distribution image, the processing core device determines that the third target coordinate information corresponds to a dummy ghost point.

7. An optical touch method used in an optical touch system for sensing N touch points triggered on an optical touch panel, wherein N is a positive integer greater than 1, and the optical touch method comprises:
obtaining a first luminance distribution image, a second luminance distribution image and a third luminance distribution image by a first image capturing device, a second image capturing device and a first auxiliary image capturing device of the optical touch system respectively, wherein the first and the second image capturing device are respectively disposed on a first terminal corner and a second terminal corner of the optical touch panel, and the first auxiliary image capturing device is disposed on a lateral side of the optical touch panel;
receiving and obtaining Nⁿ pieces of the coordinate information according to the first and the second luminance distribution images by a processing core device of the optical touch system;
defining a first viewable area of the first auxiliary image capturing device on the optical touch panel by the processing core device;
determining by the processing core device whether each of the Nⁿ pieces of the coordinate information falls within the first viewable area; and
comparing a first target coordinate information, which falls within the first viewable area, with the third luminance distribution image by the processing core device to determine whether the first target coordinate information corresponds to a real touch point.

8. The optical touch method according to claim 7, wherein the step of determining whether the first target coordinate information corresponds to a real touch point further comprises:
determining by the processing core device whether the first target coordinate information corresponds to any dark portion positions on the third luminance distribution image, if so, the processing core device determines that the first target coordinate information corresponds to a real touch point; and
if the first target coordinate information does not correspond to any dark portion positions on the third luminance distribution image, the processing core device determines that the first target coordinate information corresponds to a dummy ghost point.

9. The optical touch method according to claim 7, wherein
the processing core device obtains a plurality of linear equations by referencing a first viewable angle information and a relative position information between the first auxiliary image capturing device and the optical touch panel, and accordingly defines the first viewable area on the optical touch panel; and
wherein, the processing core device substitutes each of the Nⁿ pieces of the coordinate information into the linear equations to determine whether each of the Nⁿ pieces of the coordinate information falls within the first viewable area.

10. The optical touch method according to claim 7, further comprising:
obtaining a fourth luminance distribution image by a second auxiliary image capturing device of the optical touch system, wherein the second auxiliary image capturing device is disposed on a lateral side of the optical touch panel;
defining a second viewable area of the second auxiliary image capturing device on the optical touch panel by the processing core device;
determining by the processing core device whether each of the Nⁿ pieces of the coordinate information falls within the second viewable area;
comparing the second target coordinate information, which falls outside the first viewable area but within the second viewable area, with the fourth luminance distribution image by the processing core device to determine whether the second target coordinate information corresponds to a real touch point; and
comparing the third target coordinate information, which falls within the first viewable area and the second viewable area, with the third and the fourth luminance distribution images by the processing core device to determine whether the second target coordinate information corresponds to a real touch point.

11. The optical touch method according to claim 10, wherein the step of determining whether the second target coordinate information corresponds to a real touch point further comprises:
determining by the processing core device whether the second target coordinate information corresponds to any dark portion positions on the fourth luminance distribution image, if so, the processing core device determines that the second target coordinate information corresponds to a real touch point; and
if the second target coordinate information does not correspond to any dark portion positions on the fourth luminance distribution image, the processing core device determines that the second target coordinate information corresponds to a dummy ghost point.

12. The optical touch method according to claim 10, wherein the step of determining whether the third target coordinate information corresponds to a real touch point further comprises:
determining by the processing core device whether the third target coordinate information corresponds to a first dark portion position on the third luminance distribution image and corresponds to a second dark portion position on the fourth luminance distribution image, if so, the processing core device determines that the third target coordinate information corresponds to a real touch point; and
if the third target coordinate information does not correspond to any dark portion positions on the third luminance distribution image or if the third target coordinate information does not correspond to any dark portion positions on the fourth luminance distribution image, the processing core device determines that the third target coordinate information corresponds to a dummy ghost point.
